(19) United States
(12) Patent Application Publication
(10) Pub. No.: US 2023/0172176 A1
(43) Pub. Date: Jun. 8, 2023

(54) INVISIBLE HOOK

(71) Applicants: Jack Arnot, Fort Collings, CO (US); Thomas Boyne, Boulder, CO (US)

(72) Inventors: Jack Arnot, Fort Collings, CO (US); Thomas Boyne, Boulder, CO (US)

(21) Appl. No.: 18/073,161

(22) Filed: Dec. 1, 2022

Related U.S. Application Data
(60) Provisional application No. 63/287,493, filed on Dec. 8, 2021.

(51) Int. Cl. A01K 83/00

(52) U.S. Cl. CPC A01K 83/00

(57) ABSTRACT

An implement with particular optical properties including transparency and translucency. The implement may be used as a hook, fastener, or tool made from the transparent or translucent material. When the implement is used as a fishing hook, it can increase the catch rate.

### CROSS-REFERENCE TO RELATED APPLICATIONS

This application claims the benefit of U.S. Provisional Application No. 63/287,493, filed Dec. 08, 2021, which is hereby incorporated by reference in its entirety.

### BACKGROUND

### Technical Field

The present disclosure relates to hardware and hooks in general and more particularly to sporting tackle, including fishing hooks. Fish hooks or angles are used by anglers to impale or to snag fish. In fly fishing, fish hooks are incorporated into a lure or fly which is intended to emulate fish food. The present disclosure sets forth improvement to fish hooks used with fishing flies. But the innovations set forth here are applicable to any sporting tackle, including conventional, fly, or ice fishing angles, or in any application where transparency of the hardware is desirable, for example as hardware for hanging wall art, or coat or hat hangers.

### SUMMARY

The present disclosure contemplates use with any hook, fishing tackle, or implement where transparency is desirable. In particular, the present disclosure contemplates many styles, shapes, and sizes and is not limited to a particle type of tackle or a particular type of fishing. A fish hook in accordance with the present teachings is constructed from metal oxides or metal nitrides and is transparent such that it disappears into the shapes and colors of the background becoming less visible to fish. Therefore, the fish will not see the hook or be spooked by it. The hook may include barbs and be sintered for increased structural integrity. The hook may be made in dimensions that permit big game fishing.

### BRIEF DESCRIPTION OF THE DRAWINGS

FIG. 1 depicts a hook according to one embodiment of the invention.

FIG. 2 shows a hook according to another embodiment of the invention.

FIGS. 3A-3B depict alternative embodiments with angled ends.

FIGS. 4A-4B depict alternative embodiments of barbs.

FIG. 5 depicts a hook according to yet another embodiment of the invention.

FIGS. 6A-6M depicts various configurations of hooks.

### DETAILED DESCRIPTION

In the following detailed description, numerous specific details are set forth by way of examples in order to provide a thorough understanding of the relevant teachings of this application. It should be noted, however, that the present teachings may be practiced without such details. In other instances, known methods, procedures and components have been described at a relatively high level, without detail, in order to avoid unnecessarily obscuring aspects of the teachings.

The implement described here, may be created in in any shape or size. That is, the teachings here are applicable to any type of tackle that is used for fishing. This disclosure contemplates any type of hook for any fish species.

FIG. 1 shows a single-point hook 100. Hook 100 is fabricated from materials which render it optically transparent or translucent in an effective manner. The transparent or translucent properties allow transmission of images making the hook less visible. In some embodiments, the hook will be largely transparent underwater and mostly translucent out of water. The transparent or translucent hook acts as an invisible hook to fish and therefore increases catch rates.

Prior art hooks are made from metal, generally steel. Fish, especially in high traffic areas, are accustomed to the look and feel of these hooks. They see many float by and are generally wary of taking bait near these hooks. By way of an example, when fly fishing with a caddis fly, the hook below the body of the fly is visible and may spook fish. But when a caddis fly, constructed according to the teachings of the invention, lands on the water, to the eye of the fish looking at the fly, only the body and wings of the fly are visible to the fish. The hook disappears into the shapes and colors of the background. Therefore, the fish will not see the hook or be spooked by it. The fly will present more naturally and will attract the fish. Thus the hook appears in the most natural way possible and avoids detection, in particular by gamefish. As such, a hook embodying the present teachings will improve an angler’s catch rate.

Additionally, prior art hooks which are less visible than steel hooks, or are touted as invisible, are constructed from material and in a manner that deteriorates their mechanical properties to the point that they do not perform as a fish hook. They are brittle and without sufficient strength to function for their intended purpose. When constructed larger or with thicker dimensions to improve their mechanical properties, they are visible to the fish and do not improve catch rates. They are often not sharp enough or, when made sharp, become dull so quickly as to become impractical. In summary, even if they are advertised as a fish hook, they do not effectively function as one. With the present teachings, the hook is invisible and with the requisite mechanical properties, such as strength, pliability, and durability, so as to allow it to function as a fish hook for all types of angling.

The present teachings may be used with any type of attractant or lure, including live bait, flies, plugs, spoons, spinners, jigs, streamers, poppers, lures, nymphs, dry flies, drop shot rigs, or any device used for attracting, enticing a bite from, or securing a fish. One of ordinary skill would understand that the present teachings are applicable to a wide range of endeavors and many types of fish and angling techniques.

Turning again to FIG. 1, hook 100 includes a coupling end 101. The coupling end 101 in the embodiment of FIG. 1 is an eye. It facilitates coupling the fishing line to a lure or fly. Typically, the fly or lure is coupled to the fishing line or leader line by tying the line to the eye. The coupling end 101 may be in line with the main axis of the shank or it may be angled with respect to it. See below with regard to FIG. 5.

FIG. 1 also shows shank 102. The shank may be short or long depending on the type of fishing and the species of fish being caught. The diameter or shape of the shank may vary with these different applications. In creating flies for fly fishing, the fly may be built on and around the shank to incorporate the hook into the fly.

Pointed end 103 is located on the opposing side of the shank from the coupling end 101. In fishing, the pointed end 103 is generally pointed for impaling or snagging the fish. For hooks where no impaling function is contemplated, the pointed end need not be sharp. It may be the natural terminus of the shank. For applications where the hook is required to snag or impale, such as in fly fishing, the pointed end 103 is sharp and typically readily pierces flesh and cartilage.

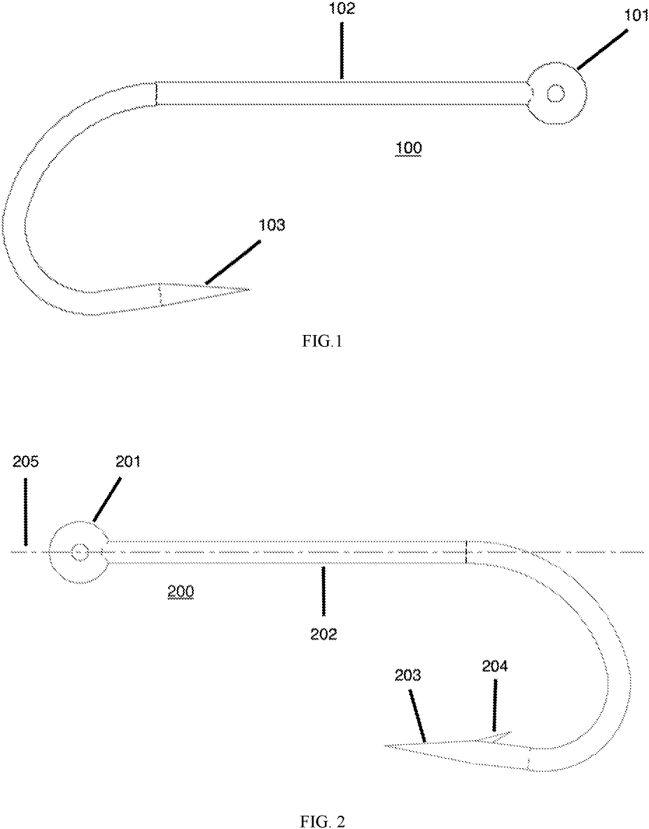

Pointed end 103, or the portion of shank 102 proximate the pointed end 103, may include one or more barbs. FIG. 2 shows a barb. A barb is typically a sharp projection located back from the point of the hook. Is may be angled away from the end 103 or shank 102 so as to make extraction of the hook difficult after point 103 is inserted. The hook 100 may include plural barbs on or near each end 103. The barbs may have different angles, may be bent in different directions, and may vary in size.

FIG. 2 shows a hook 200 including a barb 204. FIG. 2 also shows a shank 202, a pointed end 203, and a coupling end 201. The axis of the main portion of the shank 202 is shown at 205. The coupling end 201 includes an eye. In an alternate embodiment (FIG. 5), the coupling end 501 is angled from the axis of the shank 505. In FIG. 5, the barb is shown at 504.

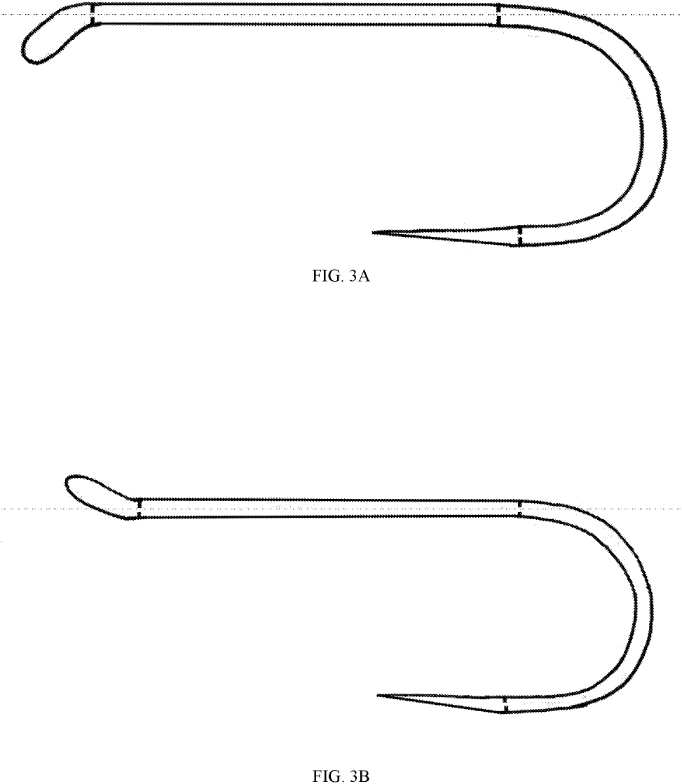

FIGS. 3A-3B show two alternative embodiments of the coupling end in an angled relationship with the axis of the shank.

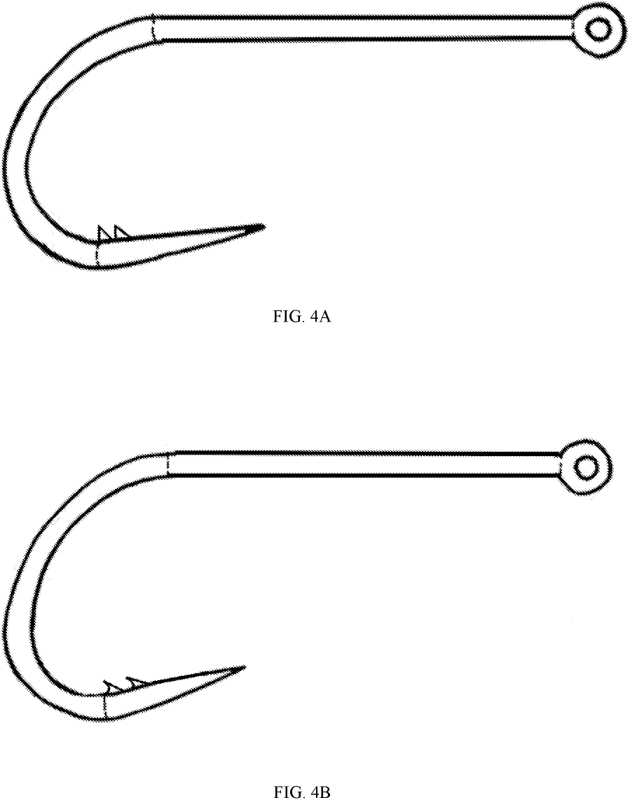

FIG. 2 shows an embodiment of a single-point barb located on the point 203. FIGS. 4A-4B show a few embodiments of multipoint barbs.

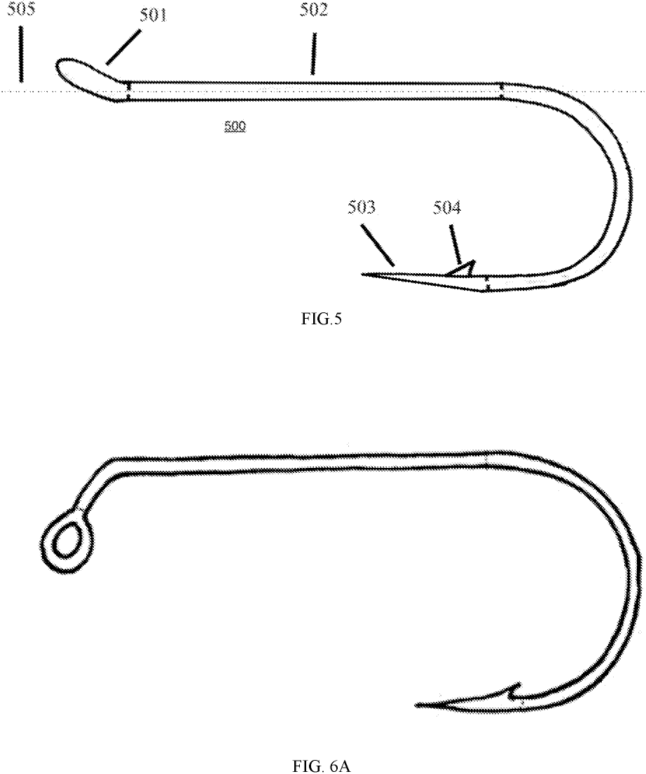

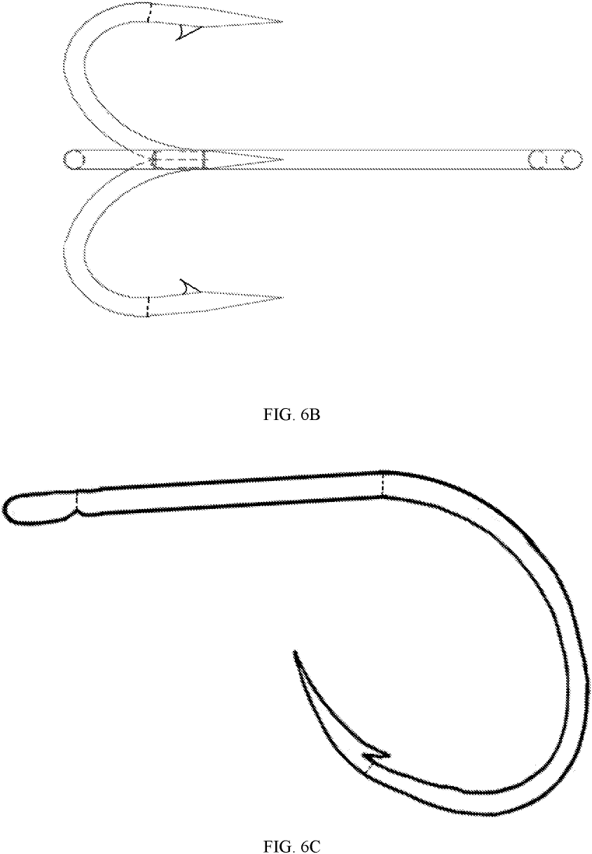

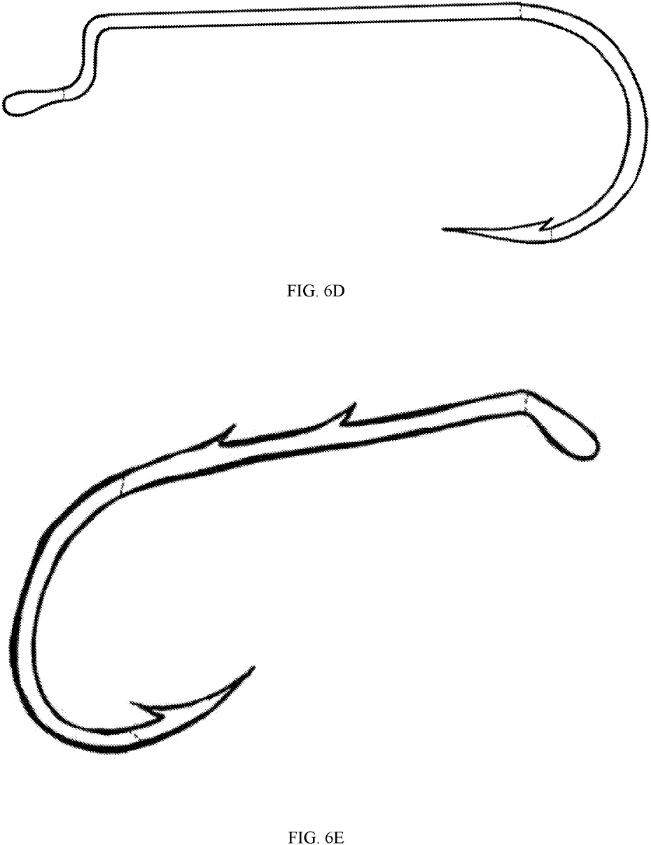

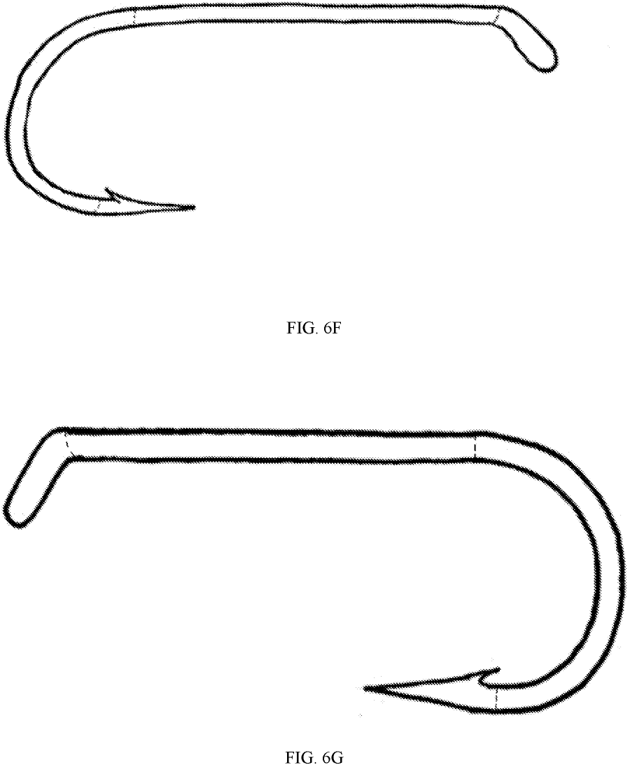

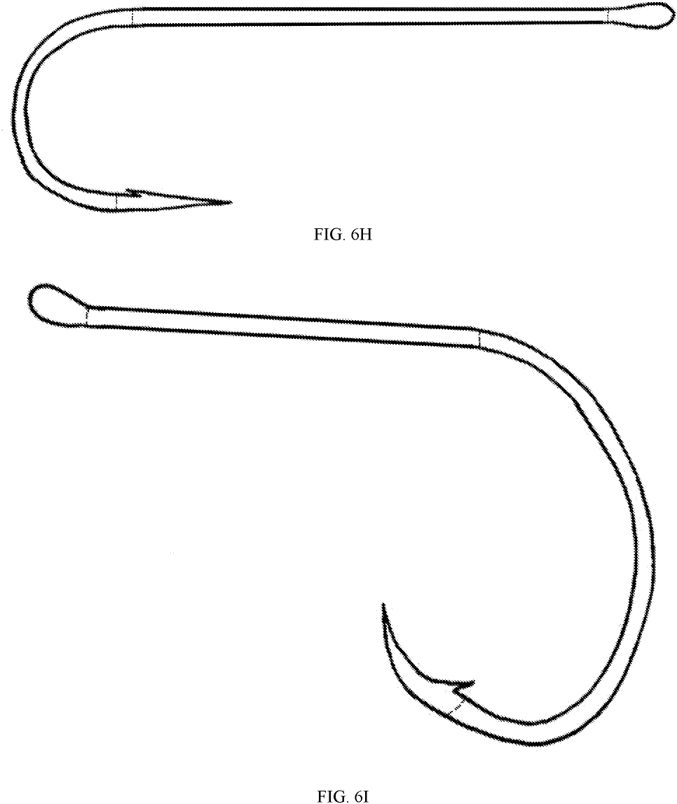

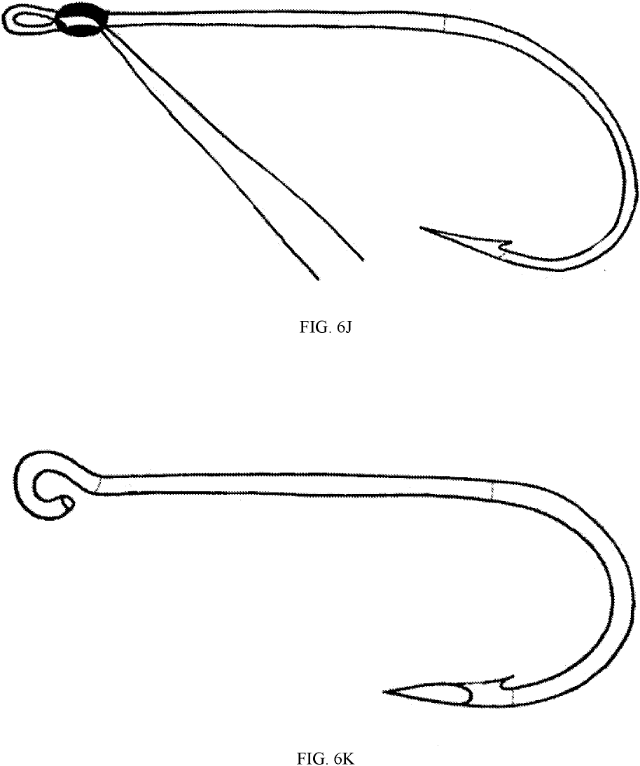

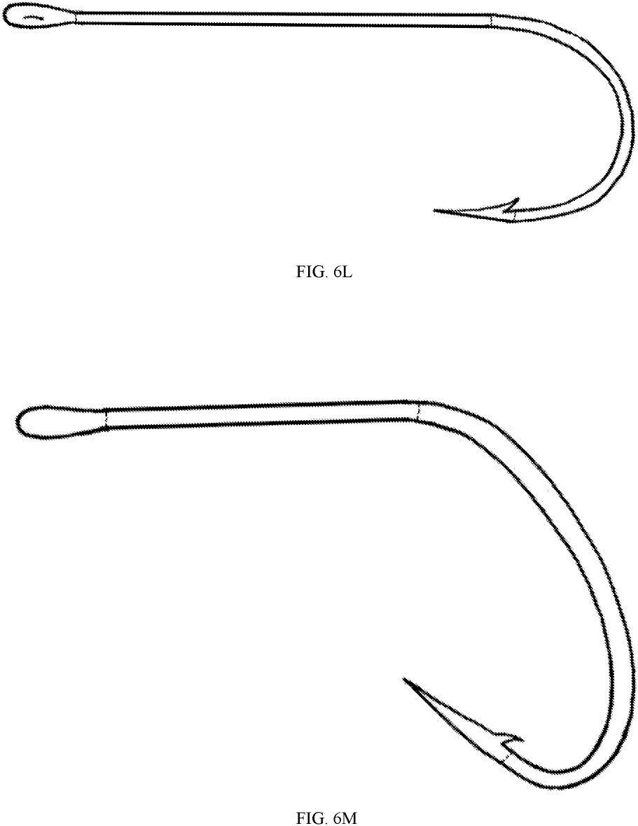

FIGS. 6A-6M show alternative examples for the types of hook in accordance with the present teachings. FIG. 6A is a jig. FIG. 6B is a treble. FIGS. 6C-6M are respectively a circle, worm, bait holder, dry fly, nymph, streamer, octopus, weedless, siwash, Aberdeen, and Kahle hooks.

The dimensions of the hooks is not limited to a particular size. For example, the length, which is the measurement from the front of the eye to the furthest point of the bend, can range from 10 mm for a small fly fishing hook to 100 mm or more for the largest of saltwater fishing hooks. The height, which is the distance from the bottom of the point to the top of the shank, can range from 4 mm in a small hook to more than 50 mm for a larger one. The circumference of the cross-section of the hook may be 0.4 mm in a smaller configuration to more than 5 mm for larger ones. The gap, which refers to the clearance in between the tip of the point and the bottom of the shank, may range from 2.5 mm to 45 mm. As one example, the embodiment of FIG. 1 may have a length of about 45.8 mm, a height of about 20 mm, a circumference of about 2 mm, and a gap of about 16 mm.

In the figures, the dashed lines shown on the surface of the hook identify the different sections of a typical fishing hook. From the eye of the hook towards the point 103, for example in FIG. 1, the first section is referred to as the eye, then the shank, the bend, and the point at 103. As can be seen in the other embodiments illustrated in the drawings multiple of these sections may be present. For example, in FIG. 6B, the treble hook has several bends and points.

The material used to create the transparent or translucent implement contemplated herein is aluminum oxide, known as alumina. Additionally, silicon nitride may also be used to practice the present teachings. In addition to alumina and silicon nitride, magnesium aluminate, aluminum oxynitride, zirconia, yttria-stabilized zirconia, or sapphire may also be used. More broadly ceramic material whose optical properties allow the invisible features described herein may be used to practice the present teachings. The material may also be a granular cross-linked complex. The material used to create the transparent or translucent implement transmits, or passes through, the majority of the light in the visible spectrum which is incident on it, making it appear invisible. The material may have a light transmission property of more than 80%, including between 80% to 95%.

The transparent or translucent implement contemplated herein can be created by a number of manufacturing methods. One method includes injection molding. In such a method, a mold is created for the implement. The molten material is mixed with water and/or additives like binders then injected into the mold. The injection molded part then goes through a process called sintering, where it is solidified and the water and other additives are removed. The part may then be post-processed in an autoclave to achieve a smooth surface finish and improve the translucency of the part. Other manufacturing methods are extrusion, slip casting, pressing, or gel casting, or other popular methods for shaping ceramic parts. Injection molding may work well for this application.

The formed implement may or may not be coated. If a coating is used, it may be ceramic or plastic. In one implementation, a transparent polymer coating may be used. In another, the coating may be polyurethane. Where desirable to bring about various characteristics or benefits, certain coatings can be used to realize these benefits. For example, where additional rigidity or structural resistance is desirable, such as in bass fishing, fly fishing, saltwater fishing, or any kind of recreational or commercial fishing activities the hook may be coated with a clear coat of polyurethane.

As mentioned above, the features of each embodiment may readily be incorporated into another of the embodiments contemplated herein. Any contemplated tackle, hook, fastener, or implement may be used in combination with the optical characteristics described herein and the materials contemplated. Moreover, any of the sizes, shapes, and configurations contemplated herein may be interchanged between various embodiments.

The present manufacturers and methods have been described using specific examples as illustrated above. But in practice, the features of each may be combined and used in other combinations. Moreover, one or more of the aspects of the invention may be combined together. The present invention may be scaled to be made larger or smaller. In summary, the aspects of the invention described herein can be adjusted and scaled consistent with the teachings herein without limitation by the specific examples set forth for illustration purposes.

Except as stated above, nothing that has been stated or illustrated is intended or should be interpreted to cause a dedication of any component, step, feature, object, benefit, advantage, or equivalent to the public, even if not expressly found in the claims.

We claim:

1. An invisible implement comprising:
a shank;
a terminal end;
a coupling end;
wherein the implement appears invisible because it transmits the majority of incident light in the visible spectrum.

2. An implement according to claim 1 wherein the implement transmits 80% or more of light in the visible spectrum.

3. An implement according to claim 1 wherein the implement is a hook.

4. An implement according to claim 1 wherein the implement is a fish hook.

5. An implement according to claim 1 wherein the implement is constructed from a ceramic.

6. An implement according to claim 1 wherein the implement is constructed from a granular cross linked complex.

7. An implement according to claim 1 wherein the implement is constructed from a granular cross linked complex with a light transmission property of 80% to 95%.

8. An implement according to claim 1 wherein the implement is a fish hook with a length smaller than 100 mm.

9. An implement according to claim 1 wherein the implement is a fish hook with a length smaller than 10 mm.

10. An implement according to claim 1 wherein the implement is a fish hook with a length larger than 100 mm.

11. An implement according to claim 1 wherein the implement is a fish hook with a length smaller than 50 mm.

12. An implement according to claim 1 wherein the implement is a fish hook with a length larger than 90 mm.

13. An implement according to claim 1 wherein the implement is a fish hook with a length between 2.5 to 45 mm.

14. An implement according to claim 1 wherein the implement is a fish hook with a height of 20 mm or larger.

15. An implement according to claim 1 wherein the implement is a fish hook with a height of 20 mm or smaller.

16. An implement according to claim 1 wherein the shank has a diameter of 0.4 mm or smaller.

17. An implement according to claim 1 wherein the shank has a diameter of 0.4 mm or larger.
